(19) United States
(12) Patent Application Publication
(10) Pub. No.: US 2002/0183668 A1
(43) Pub. Date: Dec. 5, 2002

(54) Massager

(76) Inventor: Chien-Ming Huang, Taipei (TW)

Correspondence Address: BROOKS & KUSHMAN, 1000 TOWN CENTER 22ND FL, SOUTHFIELD, MI, 48075

(21) Appl. No.: 09/874,618

(22) Filed: Jun. 5, 2001

(51) Int. Cl. A61H 1/00

(52) U.S. Cl. 601/97; 601/46

(57) ABSTRACT

A massager has a motor with a motor shaft extending out from opposite ends of the motor, a pair of linkages each rotatably and eccentrically connected to opposite ends of the motor shaft, a bridge securely attached to the linkages with a pair of flexible arms and a pair of massage balls securely mounted on the bridge. The bridge is pivotal relative to the housing so that the movement of the linkages caused by the rotation of the motor shaft drives the massage balls on opposite sides of the bridge to pivotally reciprocate.

### BACKGROUND OF THE INVENTION

1. Field of the Invention

The present invention relates to a massager, and more particularly to a massager with a bridge pivotally mounted on the massager and a pair of massage balls detachably connected to opposite ends of the bridge so as to create a rubbing and massage effect to the user when the bridge is in operation.

2. Description of Related Art

With reference to FIGS. 7 and 8, a conventional massager (50) comprises a motor (51), a pair of linkages (52) and a pair of massage balls (53). The linkages (52) are eccentrically connected to opposite ends of the motor shaft (not shown). Each of the massage balls (53) is securely engaged with one of the linkages (52). Because the linkages (52) are eccentrically engaged with the motor shaft, the motor (51) will thus drive and move the linkages (52). That is, the rotational movement of the motor shaft will be transformed into reciprocating movement of the linkage (52). Accordingly, the balls (53) securely mounted on the linkages (52) will move up and down. When the massager is against the user's skin, the up and down movement of the balls (53) generates a massage effect to the user.

However, the massaging effect generated by the monotonous up and down movement of the balls (53) can only be applied to a single limited area. When the user wants to apply the massager to a nearby area, the user will have to move the massager of this kind to the designated nearby area. Therefore, not only is the massage effect not as good as expected, but using this massager is troublesome.

To overcome the shortcomings, the present invention tends to provide an improved massager to mitigate and obviate the aforementioned problems.

### SUMMARY OF THE INVENTION

The primary objective of the present invention is to provide a massager that generates a lateral massage effect. To accomplish this objective the massager in accordance with the present invention has a motor, a bridge, a pair of massage balls and a pair of linkages. The bridge is pivotally engaged with the massager. The massage balls are detachably connected to the bridge. The motor has a shaft with a linkage securely and eccentrically connected to each end of the motor shaft. The eccentric connection of the linkages to the ends of the shaft will transform the rotation movement of the motor shaft into linear movement of the linkages. The linear movement of the linkages will be transmitted to the bridge and cause the bridge to pivotally reciprocate. Because the massage balls are securely attached to the bridge, the massage balls also reciprocate laterally.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of the massager in accordance with the present invention;

FIG. 2 is a top plan view of the massager in FIG. 1;

FIG. 3 is an enlarged perspective view of the transmission device on one side of the massager in FIG. 1;

FIG. 4 is an enlarged side plan view of the massager in FIG. 1 showing the structural relationship between the massage ball and the transmission device;

FIG. 5 is an operational front plan view of the massager in FIG. 1 showing the movement of the massage balls caused by the reciprocating movement of the bridge;

FIG. 6 is an enlarged operational side plan view of the massager in FIG. 1 showing the operation of the bridge, which drives and moves the massage balls;

FIG. 7 is a top plan view of a conventional massager; and

FIG. 8 is an enlarged perspective view of the transmission mechanism in the conventional massager, wherein the ball moves up and down due to the eccentric connection between the linkage and the motor shaft.

### DETAILED DESCRIPTION OF PREFERRED EMBODIMENT

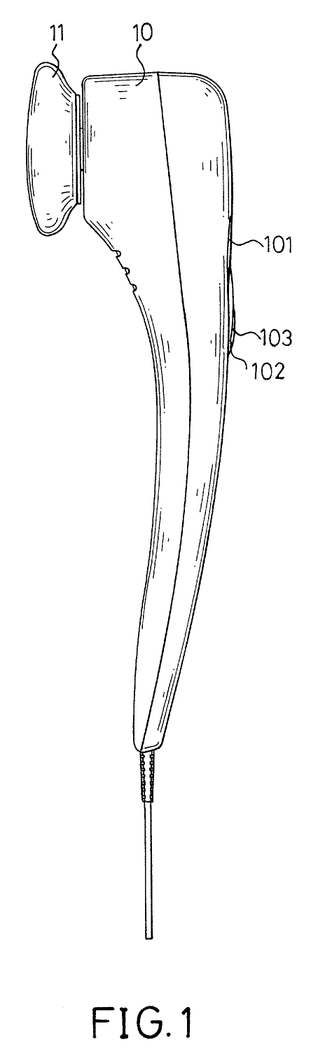

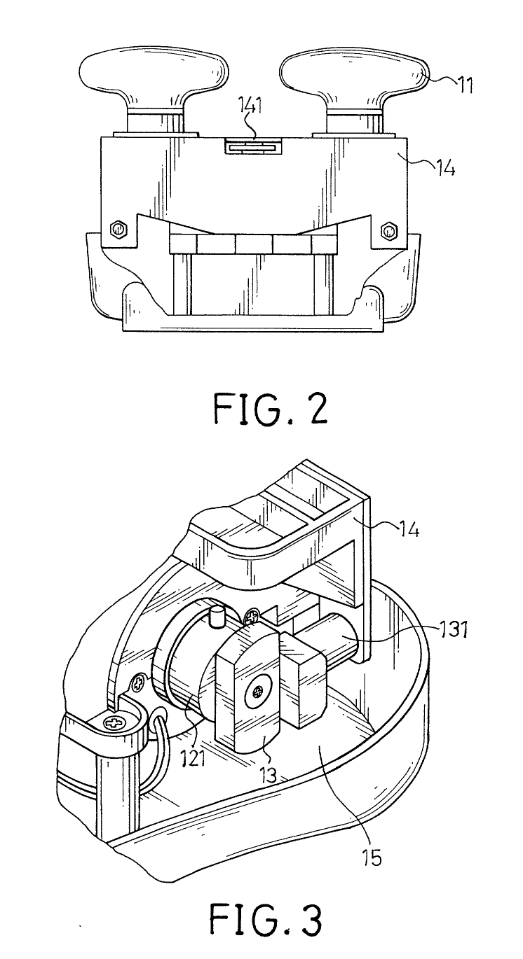

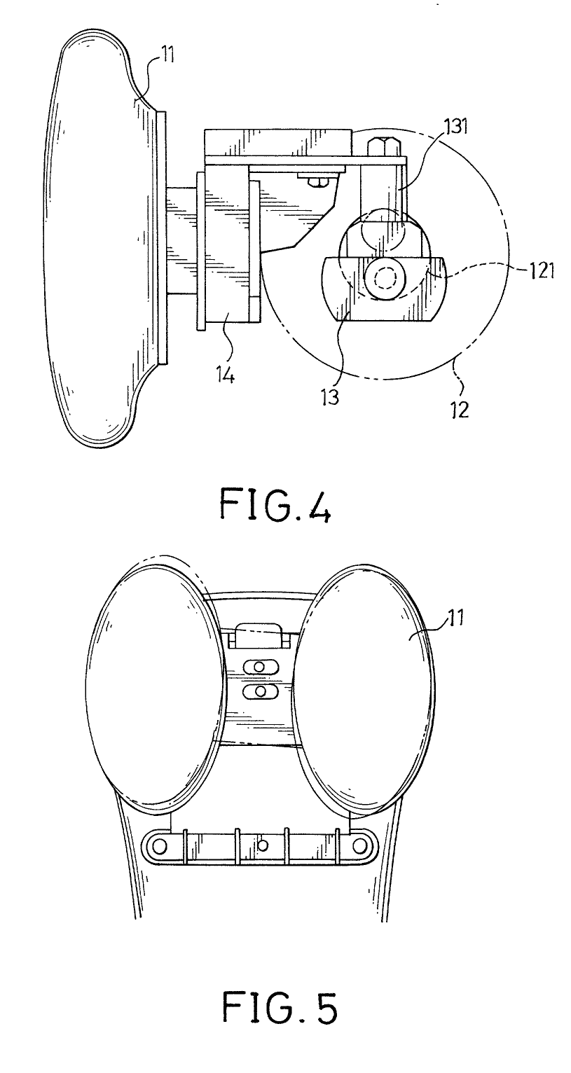

With reference to FIGS. 1, 2, 3 and 4, the massager in accordance with the present invention has a housing (10), a pair of massage balls (11), a bridge (14), a motor (12) and a pair of linkages (13).

The motor (12) is securely mounted in the housing (10) with a motor bracket (not numbered) and has a motor shaft (121) extending from each end of the motor (12). Each of the linkages (13) is eccentrically and rotatably connected to an opposite end of the motor shaft (121). The eccentric connection points on the ends of the shaft (121) are diametrically opposite to each other The bridge (14) is pivotally attached to the motor (12) retainer bracket by a pivotal connector (141) and is securely attached to both linkages (13) with corresponding flexible connecting arms (131).

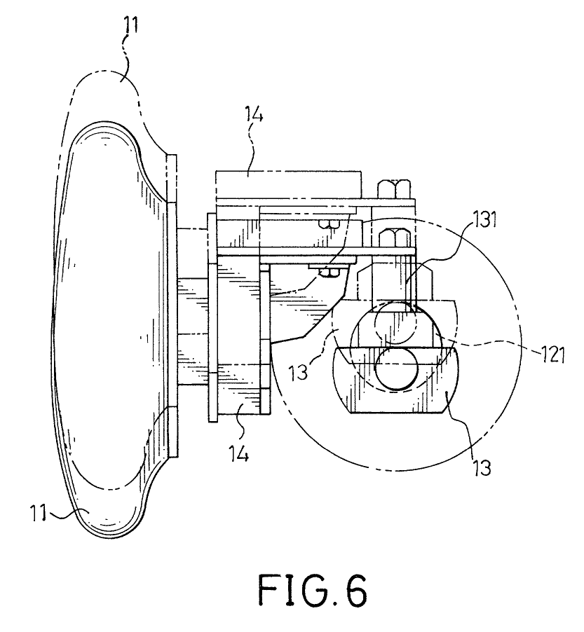

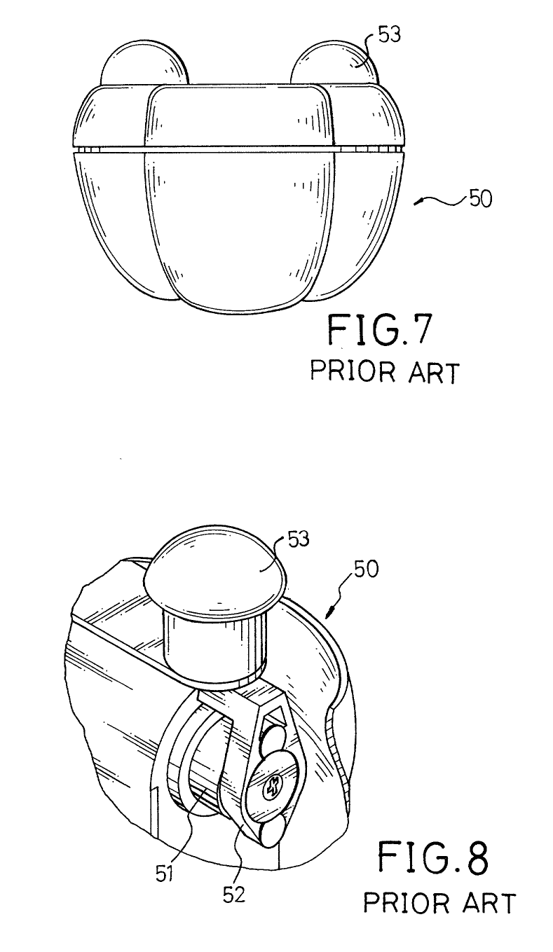

With reference to FIGS. 5 and 6 and still taking FIG. 3 for reference, when the motor (12) runs, the rotation of the motor shaft (121) drives the linkages (13) on opposite ends of the motor shaft (121) to linearly reciprocate relative to the motor (12). Accordingly, the linear movement of the linkages (13) drives the bridge (14) to pivotally reciprocate. Thus the massage balls (11) mounted on the bridge (14) pivotally reciprocate along with the bridge (14). Furthermore, the massager has a printed circuit board (15) mounted in the housing (10), and the housing (10) has control buttons (101,102,103) to respectively turn power on or off, control the speed of motor rotation and initiate or turn off heat generation. Since the control of motor speed, heat generation and power on/off are conventional in the art, further detailed description of these features is omitted.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A massager comprising:
a housing with a pair of massage balls pivotal with respect to the housing;
a motor securely mounted in the housing and having a motor shaft extending from opposite ends of the motor;
a pair of linkages each eccentrically and rotatably attached to an opposite end of the motor shaft;
a pair of flexible arms each securely attached to one of the linkages; and
a bridge pivotally attached to the motor and securely connected to the pair of flexible arms and having the massage balls securely and oppositely mounted on the bridge, such that the movement of the motor drives the linkages to reciprocate and move linearly, which consequently causes the massage balls on the bridge to pivotally reciprocate.

2. The massager as claimed in claim 1, wherein the housing has control buttons operably mounted on the housing for respectively controlling power provision, heat generation and motor rotation speed.
